(19) United States
(12) Patent Application Publication
(10) Pub. No.: US 2021/0353100 A1
(43) Pub. Date: Nov. 18, 2021

(54) Heigh Temperature Grill Cover

(71) Applicant: Timothy Driscoll, Millbury, MA (US)

(72) Inventor: Timothy Driscoll, Millbury, MA (US)

(21) Appl. No.: 17/318,783

(22) Filed: May 12, 2021

Related U.S. Application Data
(60) Provisional application No. 63/023,608, filed on May 12, 2020.

(51) Int. Cl. A47J 37/07

(52) U.S. Cl. CPC A47J 37/0786

(57) ABSTRACT

A flexible cover body is configured to shield an outdoor cooking apparatus such as a gas grill, a charcoal grill, and a smoker. The flexible cover body includes a substrate, an inner silicone layer, and an outer silicone layer. The outer silicone layer is superimposed across the substrate as the outer silicone layer and the substrate are positioned coextensive with each other. The inner silicone layer is superimposed across the substrate, opposite of the outer silicone layer, as the inner silicone layer and the substrate is positioned coextensive with each other. Collectively the substrate, the inner silicone layer, and the outer silicone layer form a ultraviolet light resistance and waterproof cover that enable the user to immediately cover the grill or smoker without having to wait for the grill or smoker to cool down.

### FIELD OF THE INVENTION

The present invention relates generally to grill covers. More specifically, the present invention is a high temperature, heavy duty, all season outdoor cover that is utilized to cover grills and smokers, immediately after the cooking.

### BACKGROUND OF THE INVENTION

Existing grill/smoker covers and other custom manufactured grill/smoker covers are generally made from polyester, vinyl, and other related industry standard material. Generally, these existing grill/smoker covers material weight less than 6 oz/sq. yard. Due to excessive heat of the grill or smoker, consumers are unable to utilize these existing grill/smoker covers to cover-up the grill or smoker, immediately after the cooking, as the excessive heat can compromise the structural integrity of the existing grill/smoker covers. As a result, consumers normally wait until the grill or smoker to cool down for time period. Then the grill or smoker can be covered with the existing grill/smoker covers. Because of the time delay, consumers tend to forget the covering process of the grill or smoker thus resulting rain, snow, dirt, and other outside elements getting on the grill or smoker and the existing grill/smoker covers.

It is an objective of the present invention to provide a high temperature, heavy duty, all season outdoor cover that is utilized to cover grills and smokers, immediately after the cooking. More specifically, the present invention is made from a heavy duty substrate that is covered with silicone outer layer and silicone inner layer. Due to the material properties of the present invention, consumers can immediately cover the grill or smoker without having to wait for the grill or smoker to cool down.

### BRIEF DESCRIPTION OF THE DRAWINGS

FIG. 1 is a perspective view of the present invention, wherein dash lines illustrates an internally positioned outdoor cooking apparatus.

FIG. 2 is a top perspective view of the present invention.

FIG. 3 is a bottom perspective view of the present invention.

FIG. 4 is a schematic illustration showing the positioning of the substrate, the inner silicone layer, and the outer silicone layer.

### DETAIL DESCRIPTIONS OF THE INVENTION

All illustrations of the drawings are for the purpose of describing selected versions of the present invention and are not intended to limit the scope of the present invention.

The present invention a high temperature, heavy duty, all season outdoor cover that is utilized to cover grills and smokers, immediately after the cooking, without waiting for the grill or the smoker to cool down. Due to the immediate covering of the grill or the smoker, the present invention is always able to protect the grill or the smoker from outside elements such as dirt, snow, rain.

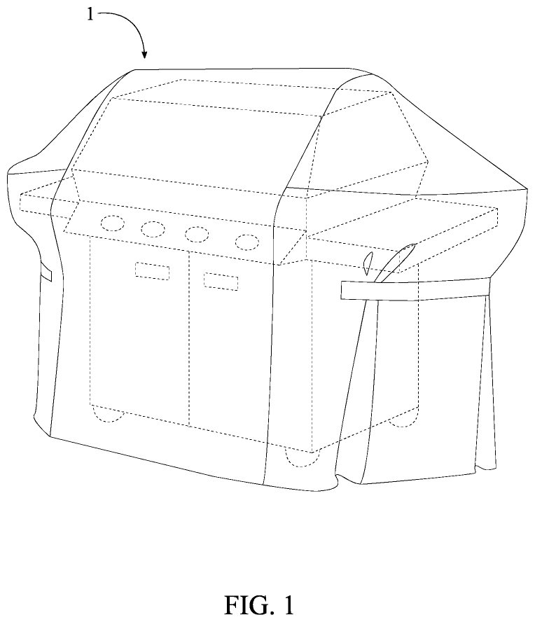

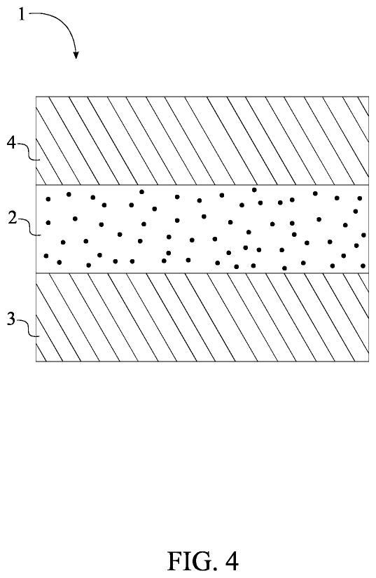

In reference to FIG. 1-3, the present invention is a flexible cover body 1 that is configured to shield an outdoor cooking apparatus. The present invention can be utilized to cover a gas grill, a charcoal grill, a smoker, a barbeque apparatus, or any other type of cooking apparatus that can be exposed to outside elements. The flexible cover body 1 comprises a substrate 2, an inner silicone layer 3, and an outer silicone layer 4 as shown in FIG. 4. More specifically, the outer silicone layer 4 is superimposed across the substrate 2. The inner silicone is superimposed across the substrate 2 and positioned opposite of the outer silicone layer 4. Furthermore, the outer silicone layer 4 and the substrate 2 are positioned coextensive with each other so that the outer silicone layer 4 can fully cover an outer surface of the substrate 2. Similarly, the inner silicone layer 3 and the substrate 2 are positioned coextensive with each other so that the inner silicone layer 3 can fully cover an inner surface of the substrate 2.

The flexible cover body 1 preferably utilizes a fiberglass substrate with areal weight of 12.7 oz/sq/yd as the substrate 2. However, the substrate 2 is not limited to the fiberglass substrate and can be any other type of high strength and flexible material that can be adhered to the inner silicone layer 3 and the outer silicone layer 4.

The outer silicone layer 4 forms an outer protective coating for the flexible cover body 1 so that the flexible cover body 1 can be protected from outside elements. More specifically, the flexible cover body 1 is able to resist ultraviolet light and functions as waterproof cover due to the placement of the outer silicone layer 4. Furthermore, the outer silicone layer 4 provides additional structural integrity to the substrate 2 to prevent deterioration with respect to an outer surface of the present invention. Preferably, the outer silicone layer 4 adds an approximate weight of 5.30 oz per sq. yard so that the present flexible cover body 1 is able to function as a weighted cover.

The inner silicone layer 3 forms an inner protective coating for the flexible cover body 1 so that the flexible cover body 1 can be protected from inside elements such as excessive amount of heat energy that radiates through the outdoor cooking apparatus. More specifically, the flexible cover body 1 is preferably able to absorb up to 500 degrees of Fahrenheit without compromising the structural integrity of the flexible cover body 1. As a result, the flexible cover body 1 can easily provide a safe surrounding for children immediately after the cooking process is completed. Furthermore, the inner silicone layer 3 provides additional structural integrity to the substrate 2 to prevent deterioration with respect to an inner surface of the present invention. Preferably, the inner silicone layer 3 adds an approximate weight of 5.30 oz per sq. yard so that the present flexible cover body 1 is able to function as a weighted cover.

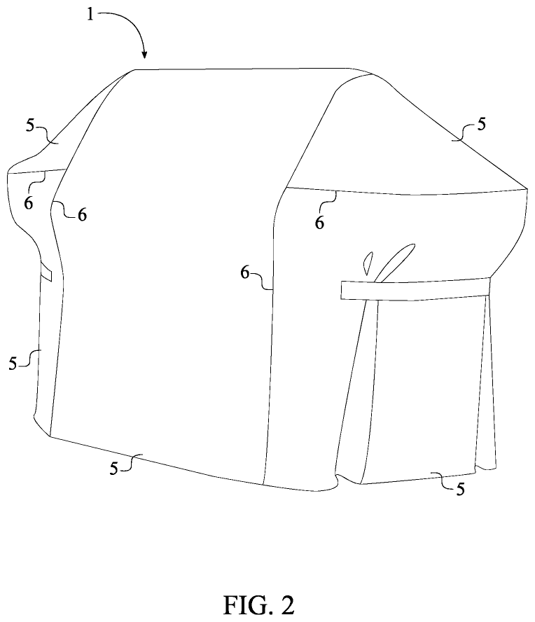

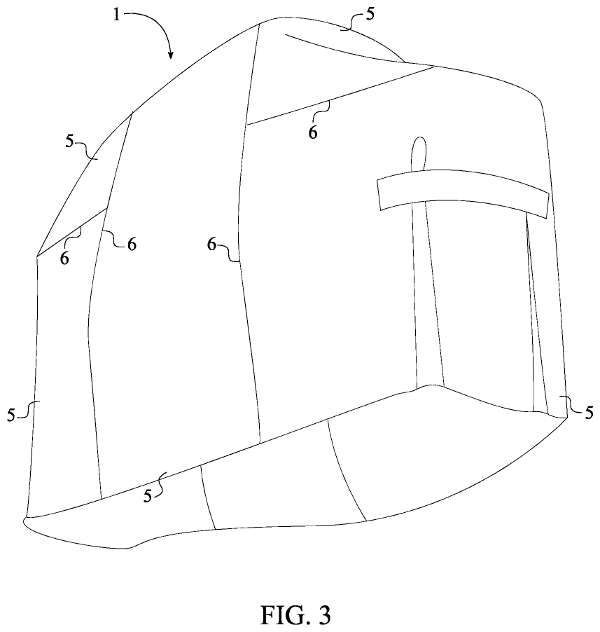

As shown in FIG. 2-3, the present invention further comprises a plurality of high temperature seams 6, and the flexible cover body 1 comprises a plurality of cover panels 5. The arrangement of the plurality of cover panels 5 delineates the general shape of the flexible cover body 1 so that the present invention can be customized to different types of grills and smokers. More specifically, each adjacent pair of panels from the plurality of cover panels 5 is stitched to each other by a corresponding seam from the plurality of high temperature seams 6 so that the plurality of cover panels 5 can be configured to shield the outdoor cooking apparatus. Each of the plurality of high temperature seams 6 is completed with high temperature threading to maintain the structural integrity of the present invention.

Depending upon different embodiment of the flexible cover body 1, the present invention can further comprise at least one fastening strap. More specifically, the at least one fastening strap is externally connected onto the outer silicone layer 4 and positioned adjacent to a bottom edge of the flexible cover body 1. As a result, the at least one fastening strap is able to crimp the bottom edge of the flexible cover body 1 to prevent accidental displacement of the present invention that can cause by high wind.

Depending upon different embodiment of the flexible cover body 1, the present invention can further comprise at least one vent opening and at least one flap. More specifically, the at least one vent opening traverses through the flexible cover so that any type of moisture that may trap within the present invention can be evaporated. The at least one flap is hingedly connected to the outer silicone layer 4 and positioned over the at least one vent so that outside element does not pass through the at least one vent.

Although the invention has been explained in relation to its preferred embodiment, it is to be understood that many other possible modifications and variations can be made without departing from the spirit and scope of the invention as hereinafter claimed.

What is claimed is:

1. A high temperature grill cover comprising;
a flexible cover body;
the flexible cover body being configured to shield an outdoor cooking apparatus;
the flexible cover body comprising a substrate, an inner silicone layer, and an outer silicone layer;
the outer silicone layer being superimposed across the substrate;
the outer silicone layer and the substrate being positioned coextensive with each other;
the inner silicone layer being superimposed across the substrate, opposite of the outer silicone layer; and
the inner silicone layer and the substrate being positioned coextensive with each other.

2. The high temperature grill cover as claimed in claim 1, wherein the flexible cover body is able to resist ultraviolet light.

3. The high temperature grill cover as claimed in claim 1, wherein the flexible cover body is able to absorb up to 500 degrees of Fahrenheit.

4. The high temperature grill cover as claimed in claim 1, wherein the flexible cover body is waterproof.

5. The high temperature grill cover as claimed in claim 1 comprising;
a plurality of high temperature seams;
the flexible cover body comprising a plurality of cover panels;
each adjacent pair of panels from the plurality of cover panels being stitched to each other by a corresponding seam from the plurality of high temperature seams; and
the plurality of cover panels is configured to shield the outdoor cooking apparatus.

6. The high temperature grill cover as claimed in claim 5, wherein the outdoor cooking apparatus is selected from a group consisting of a gas grill, a charcoal grill, and a smoker.
